(19) United States
(12) Patent Application Publication
(10) Pub. No.: US 2001/0054625 A1
(43) Pub. Date: Dec. 27, 2001

(54) Device for collecting and absorbing drips on a fluid container

(76) Inventor: Jerry Iggulden, Santa Barbara, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/921,618

(22) Filed: Jul. 31, 2001

Related U.S. Application Data
(62) Division of application No. 09/549,905, filed on Apr. 14, 2000.

(51) Int. Cl. G01F 11/06

(52) U.S. Cl. 222/321.9

(57) ABSTRACT

In one embodiment, a device for collecting and absorbing drips on an exterior of a fluid container comprises an elongated strip of laminated construction. A material substantially impervious to the fluid in the container is adhesively bonded to a layer of absorbent material. A further layer of adhesive is applied to the other side of the absorbent material so that the strip may be secured to the exterior of the fluid container. In another embodiment, an absorbent material is applied to an elongated strip and an adhesive is applied in regions adjacent to the ends of the strip so that it can be wrapped around and secured to a fluid container. In another embodiment, a band of absorbent material is secured to the neck of a fluid container within a “capsule” which encloses the spout of the container prior to opening.

### BACKGROUND OF THE INVENTION

1. Field of the Invention

The present invention relates generally to the field of fluid containers and, more particularly, to a device for collecting and absorbing drips of fluid that run down the side of a container after fluid is dispensed therefrom.

2. Background

Fluid dripping down the side of a fluid container is a common everyday annoyance. Quite often, table linens become soiled or stained as a result of drips on containers for beverages, condiments and the like. For example, a few drops of red wine dripping down the side of a wine bottle can easily ruin an expensive tablecloth. A number of approaches have been taken to solve this problem. A common solution, frequently used in restaurants, is the use of a cloth to cradle a bottle of wine as it is poured. The cloth collects any inadvertent drips of wine and can be used to wipe the outside of the bottle before the bottle is placed back on the table. This is a less than ideal solution, since the cloth then becomes stained and will likely need to be discarded. Another common solution is the use of a coaster. This is also less than ideal since drips deposited on the coaster may nevertheless find their way to the table surface.

A number of devices have been proposed for absorbing drips on the neck of a bottle. For example, U.S. Pat. No. 447,635 discloses an absorbent bottle collar made of a strip of blotting paper or the like, which is held in place around the neck of a bottle with a wire or other tie. U.S. Pat. No. 1,182,993 discloses a drip guard for a bottle comprising an absorbent elastic band. U.S. Pat. No. 3,063,590 discloses a drip arrester for a bottle in which an absorbent inner layer is laminated to a relatively non-absorbent outer layer. U.S. Pat. No. 4,487,583 discloses a dribble ring made of an absorbent foam having a plastic or rubber coating on the outer circumference and bottom of the ring. U.S. Pat. No. 5,484,635 discloses a drip catcher in the form of a waterproof pocket filled with an absorbent material that is adhesively secured to the outside of a fluid container

### SUMMARY OF THE INVENTION

The present invention represents an improvement over the drip-catching devices of the prior art. In one embodiment, a device for collecting and absorbing drips on an exterior of a fluid container comprises an elongated strip of laminated construction. A material substantially impervious to the fluid in the container is adhesively bonded to a layer of absorbent material. A further layer of adhesive is applied to the other side of the absorbent material so that the strip may be secured to the exterior of the fluid container. In another embodiment, an absorbent material is applied to an elongated strip and an adhesive is applied in regions adjacent to the ends of the strip so that it can be wrapped around and secured to a fluid container. In another embodiment, a band of absorbent material is secured to the neck of a fluid container within a “capsule” which encloses the spout of the container prior to opening.

### BRIEF DESCRIPTION OF THE DRAWINGS

FIG. 1 is a perspective view of a first embodiment of the present invention.

FIG. 2 is a cross-sectional view taken through line 2-2 of FIG. 1.

FIG. 3 illustrates a method for manufacturing the device shown in FIGS. 1 and 2.

FIG. 4 is a plan view of an alternative embodiment of the invention.

FIG. 5 is a side view of the device shown in FIG. 4.

FIG. 6 is a perspective view of another alternative embodiment of the invention.

FIG. 7 is a perspective view of still another alternative embodiment of the invention.

FIG. 8 is a perspective view of a modification of the embodiment shown in FIG. 7.

FIG. 9 is a partial cross-sectional view of yet another alternative embodiment of the invention.

FIG. 10 is partial cross-sectional view of the embodiment of FIG. 9 after it has been prepared for use.

### DETAILED DESCRIPTION OF THE INVENTION

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods and devices are omitted so as to not obscure the description of the present invention with unnecessary detail.

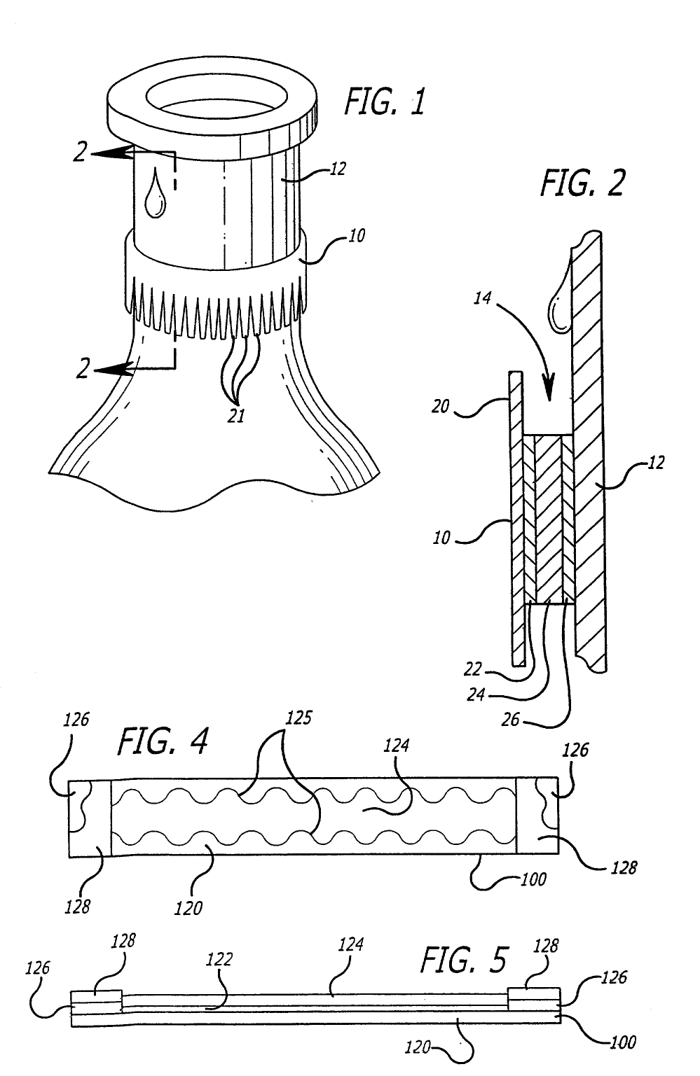

FIG. 1 illustrates a first embodiment 10 of the present invention applied to the neck of a fluid container 12, such as a wine bottle. The layered construction of device 10 is illustrated in the cross-sectional view of FIG. 2. The outermost layer 20 comprises a thin, elongated strip of a material that is substantially impervious to the fluid in the container. For most applications, such as wine bottles and the like, strip 20 may be made of a semi-rigid plastic material, such as Mylar® or the like. Strip 20 may have a plurality of slits or notches 21 along its lower edge so that it can conform to a container having a tapered neck. Next to strip 20 is a layer 22 of an adhesive material, such as a double-sided adhesive tape. Layer 24 comprises an absorbent material. A variety of materials may be used, depending upon the characteristics and volume of the fluid to be absorbed. For applications such as a drip catcher on a wine bottle, a paper material, such as commonly used for paper towels, tissues or blotters, may be used. Woven materials, such as felt or cotton gauze and open-cell foam materials may also be suitable. Layer 26 again comprises an adhesive, such as a double-sided adhesive tape.

Layers 22, 24 and 26 are preferably narrower than strip 20 so that a channel or gutter 14 is created adjacent to the outer surface of fluid container 12. This aids in the collection of drips as they descend the side of container 12 and guides them to the layer of absorbent material 24. This is one reason why it is desirable to make strip 20 of a material that is substantially impervious to the fluid. Strip 20 also acts as a barrier for fluid collected in absorbent layer 24 so that an individual handling fluid container 12 will not be directly exposed to the collected fluid. The outer surface of strip 20 may be imprinted with a decorative design, a logotype or an advertising message. Thus, for example, if device 10 is applied to a wine bottle in a restaurant, strip 20 may be imprinted with the name and/or logotype of the restaurant.

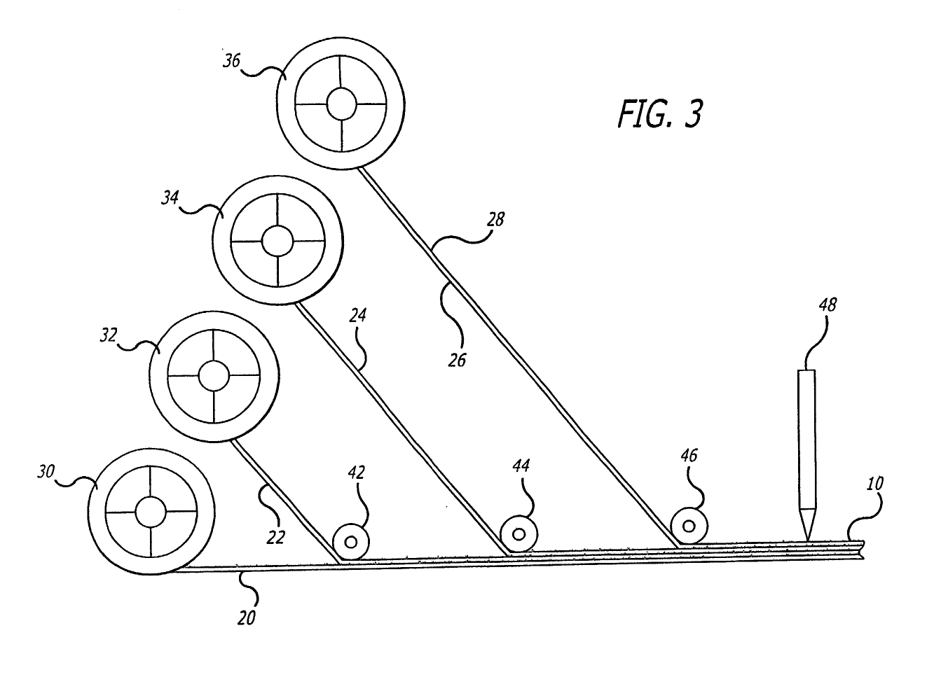

FIG. 3 illustrates a method by which device 10 may be conveniently manufactured. Each layer is fed from a corresponding spool and laminated to make the final product. The material for layer 20 is fed from spool 30 and a double-sided adhesive tape for layer 22 is fed from spool 32. These are laminated under pressure roller 42. Next, the absorbent material for layer 24 is fed from spool 34 and laminated to adhesive layer 22 under pressure roller 44. Finally, a double-sided adhesive tape for layer 26 is fed from spool 36 and laminated to absorbent layer 24 under pressure roller 46. Adhesive layer 26 preferably includes a backing material 28 to protect the adhesive until device 10 is applied to a fluid container. After all the layers are laminated, the resulting strip passes under guillotine chopper 48 to be cut to the appropriate length. For a typical 750 milliliter wine bottle, the length of finished device 10 is preferably in the range of approximately 3½ inches to 5½ inches. The width of device 10 is not critical, provided that there is a sufficient quantity of absorbent material to absorb the amount of fluid that may be anticipated to drip down the fluid container. For a wine bottle device, the width of device 10 is preferably in the range of approximately ⅜ inch to 1 inch. The preferred thickness of absorbent material 24 is likewise a function of the anticipated volume of absorbed fluid. However, it is important that the thickness be sufficient so that the gutter 14 will be large enough to receive a drip of fluid. If the gutter is too narrow (i.e., if absorbent layer 24 is too thin), drips will have a tendency to flow across the gutter and down the side of layer 20, thereby defeating the purpose of device 10.

An alternative embodiment 100 of the invention is illustrated in FIGS. 4 and 5. Device 100 is generally similar in construction to device 10. Layer 120 serves the same functions as layer 20 of the previously-described embodiment and may be made of the same fluid-impervious material. Absorbent layer 124, however, is quite different from layer 24. In this embodiment, absorbent layer 124 is formed with a powdered or granulated material. A material particularly suitable for use in this embodiment is a cross-linked acrylic polymer marketed by Chemdal Corporation of Arlington Heights, Illinois under the trademark Aridall®. This material is highly effective in absorbing aqueous fluids, such as wine. Layer 124 may be formed with scalloped edges 125, as illustrated, to increase the surface area that intercepts drips of fluid. The material for absorbent layer 124 is secured to layer 120 with a suitable adhesive 122. The adhesive is preferably a non-water based liquid adhesive that is applied with a sprayer, roller or brush. One such suitable adhesive is Scotch® brand “Photo Mount” spray adhesive.

In this embodiment, it is not practical to apply another adhesive layer over the absorbent layer. Therefore, in order to attach device 100 to a fluid container, adhesive regions 126 are provided at each end of device 100. The adhesive used in regions 126 may be a double-sided adhesive tape as used for layers 22 and 26 of the previously-described embodiment. A suitable backing material 128 may be applied over adhesive regions 126 or over the entire back of device 100, thereby protecting absorbent layer 124. To apply device 100 to a fluid container, one of adhesive areas 126 is attached directly to the outside surface of the container and the device is then wrapped around with the other adhesive region 126 being applied to the exposed surface of layer 120.

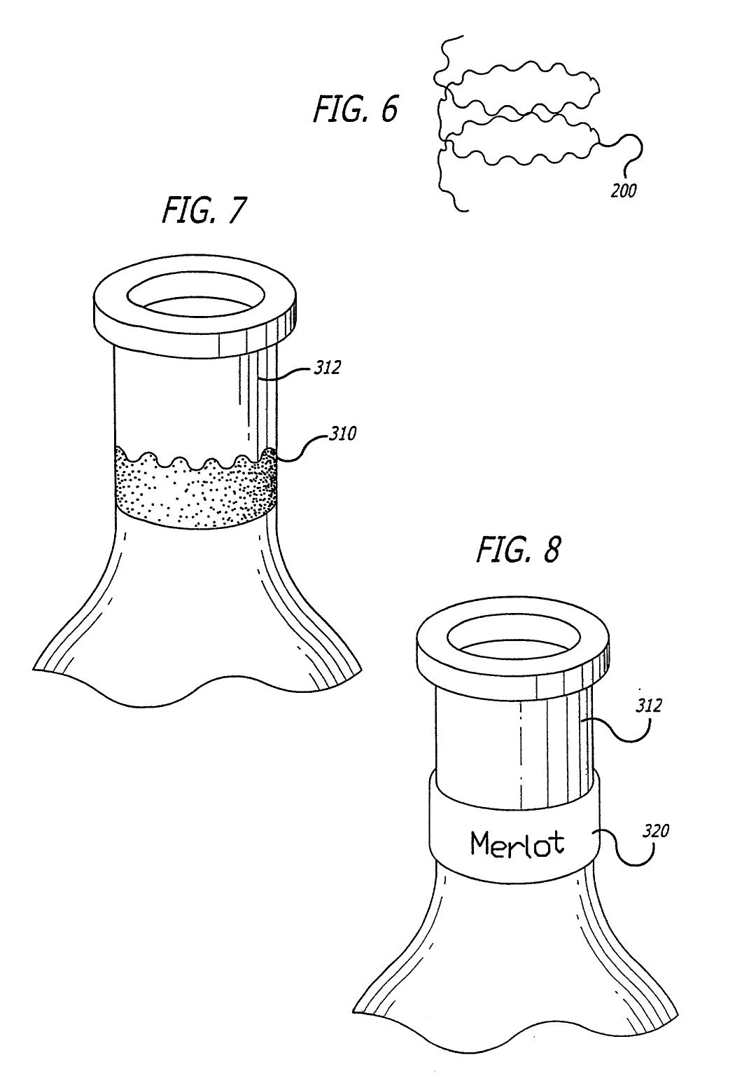

Another alternative embodiment 200 of the present invention is illustrated in FIG. 6. Device 200 comprises a wire that has been coated with an absorbent material, such as the Aridall® material described above. The wire is formed into a shape to encircle a portion of a fluid container, such as the neck of a wine bottle. Device 200 may have undulations as illustrated in FIG. 6 to increase the surface area available for absorbing drips. The wire member of device 200 is preferably made of a sufficiently resilient material and is formed into a helical shape so that the device can be applied to containers of varying diameters and will maintain intimate contact with the outside surface of the container. The “wire” may be metallic or may be formed of a resilient plastic material, such as Nylon.

The previously described embodiments of the invention comprise devices that are applied as a separate item to a fluid container. These may be applied by a consumer or may be applied to the container at any appropriate time during the container manufacturing process or container filling process. The present invention may also be embodied as an absorbent coating applied directly to the fluid container as illustrated in FIG. 7. Here, fluid container 312 has a drip-absorbing region 310 on the neck of the container or otherwise proximate to an aperture through which fluid is dispensed. Drip-absorbing region 310 may comprise a powdered or granulated absorbent material, such as the Aridall® material described above, or other suitably absorbent “flocking” material. In such case, a suitable adhesive is applied to the fluid container in the drip-absorbing region to bind the absorbing material thereto. This may be conveniently accomplished, for example, during a bottling process. Drip-absorbing region 310 may also comprise other absorbent materials, including paper materials, woven materials, etc., as described in connection with device 10.

Referring now to FIG. 8, a drip-absorbing region 310 as described above may have an outer layer 320 made of a plastic or other fluid-impervious material. Layer 320 may extend above the drip-absorbing region to form a channel or gutter as has been previously described. Also, layer 320 may be imprinted with a decorative design, a logotype or an advertising message. Thus, layer 320 and the underlying drip-absorbing region 310, may be applied to a fluid container in place of a conventional neck label.

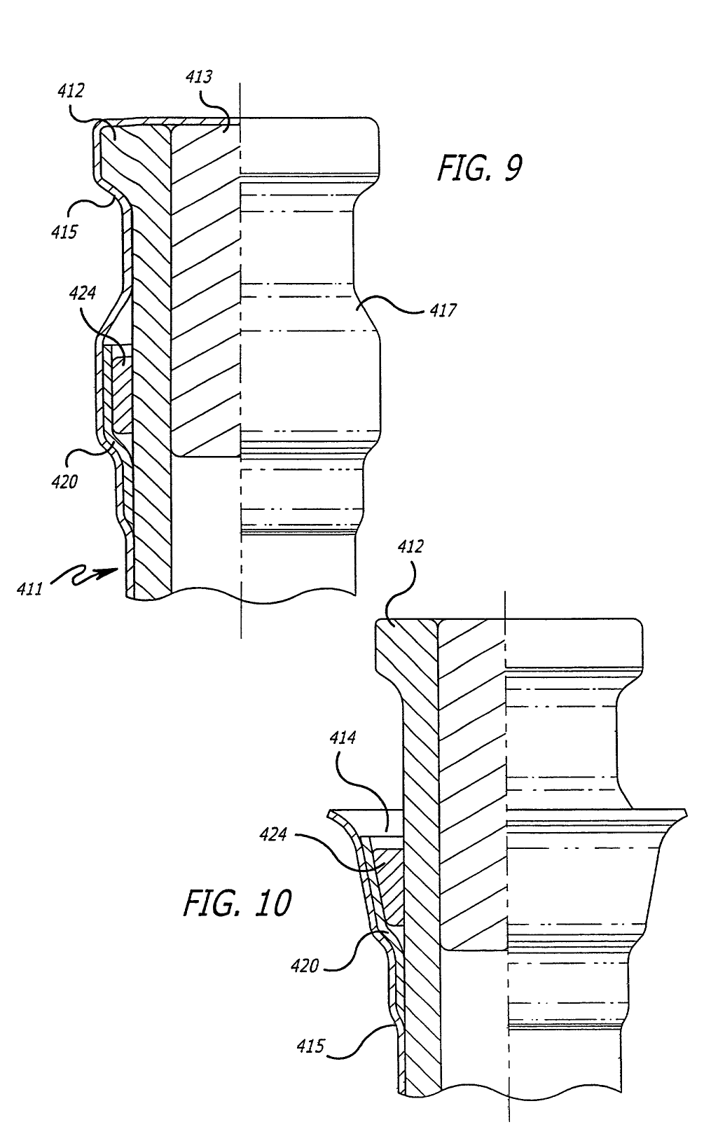

FIG. 9 illustrates another embodiment of the present invention. Here, a layer of absorbent material 424 is placed around the neck 411 of a fluid-containing bottle 412. Bottle 412 has a metallic foil or plastic “capsule” 415 of the type that is commonly used to seal the cork 413 of a bottle of still wine. The absorbent layer 424 is disposed within capsule 415 and is surrounded by a band 420 made of a plastic or other substantially fluid-impervious material. When bottle 412 is opened, at least the upper portion of capsule 415 must be removed to gain access to the cork 413. Traditionally, this is accomplished by using a foil cutter to slit the capsule circumferentially around the neck of the bottle just below the lip of the bottle. Many capsules, particularly those made of plastic, are now provided with a tear strip so that a foil cutter is not required. Absorbent layer 424 may be exposed in a similar manner, as illustrated in FIG. 10. A foil cutter or tear strip 417 is used to open the capsule immediately above the location of absorbent layer 424. The resiliency of the absorbent material aids in urging both the capsule 415 and band 420 radially outward, thereby opening gutter 414. Band 420 may be made of suitably resilient material and/or may be formed with an upward opening flare to insure that an adequately dimensioned gutter is formed. The capsule material itself may perform this function, in which case a separate band 420 is not necessary. In some applications, particularly for relatively viscous fluids such as cooking oil, honey, syrup, etc., a layer of absorbent material 424 may not be necessary. A gutter 414 alone may be sufficient to collect drips of such viscous fluids. Fluid collecting in the gutter may then be removed with a sponge or towel.

It will be recognized that the above-described invention may be embodied in other specific forms without departing from the spirit or essential characteristics of the disclosure. Thus, it is understood that the invention is not to be limited by the foregoing illustrative details, but rather is to be defined by the appended claims. In particular, whereas the invention has been specifically described in terms of embodiments intended for use on a wine bottle, the invention is also applicable to containers for other fluids, including, for example, household products, such as glue, paint, oil, etc. and kitchen products such as honey, catsup, vinegar, cooking oil, sauces, dressings, etc.

What is claimed is:

1. A device for collecting and absorbing drips on an exterior of a fluid container comprising:
an elongated strip of a material substantially impervious to the fluid;
a first layer of adhesive applied to a first side of the strip;
a layer of absorbent material applied to the first layer of adhesive; and
a second layer of adhesive applied to the absorbent material.

2. The device of claim 1 further comprising a protective layer applied to the second layer of adhesive.

3. The device of claim 1 wherein the strip is wider than the layer of absorbent material.

4. The device of claim 1 wherein the strip is a semi-rigid plastic material.

5. The device of claim 1 wherein the strip includes a plurality of notches transverse to a direction of elongation.

6. The device of claim 1 wherein the layer of absorbent material has a scalloped edge.

7. A device for collecting and absorbing drips on an exterior of a fluid container comprising:
an elongated strip of a semi-rigid material substantially impervious to the fluid;
an adhesive applied to a first side of the strip in a first region adjacent to a first end of the strip and in a second region adjacent to a second end of the strip;
an absorbent material applied to the first side of the strip in a third region extending substantially the entire length of the strip between the first and second regions.

8. The device of claim 7 further comprising a protective layer applied to the adhesive in the first and second regions.

9. The device of claim 7 wherein the absorbent material is narrower than the strip.

10. The device of claim 7 wherein the absorbent material is a granulated material.

11. The device of claim 7 wherein the strip includes a plurality of notches transverse to a direction of elongation

12. The device of claim 7 wherein the layer of absorbent material has a scalloped edge.

13. A device for collecting and absorbing drips on an exterior of a fluid container comprising:
a resilient elongated substrate formed to encircle a portion of the fluid container;
an absorbent material applied to the substrate.

14. The device of claim 13 wherein the substrate is formed into a helical shape.

15. The device of claim 13 wherein the substrate is formed to include a plurality of undulations.

16. A fluid container having a neck portion comprising a layer of adhesive applied to a region of the container encircling the neck portion and an absorbent material applied to the layer of adhesive.

17. The fluid container of claim 16 further comprising a band of material substantially impervious to the fluid encircling the absorbent material.

18. The fluid container of claim 16 wherein the region of the container to which the layer of adhesive is applied has a scalloped edge.

19. A device for collecting and absorbing drips on an exterior of a fluid container having a neck and a spout comprising:
a band of absorbent material disposed around the neck of the container;
a capsule of material substantially impervious to the fluid covering the spout and at least a portion of the neck of the container, including the band of absorbent material;
wherein at least a portion of the capsule is removed to pour fluid from the spout, thereby exposing the absorbent material.

20. The device of claim 19 further comprising a band of material substantially impervious to the fluid encircling the band of absorbent material.

21. The device of claim 20 wherein the band of substantially fluid-impervious material extends axially closer to the spout than the band of absorbent material, thereby forming a gutter to collect drips of fluid.

22. The device of claim 19 wherein the capsule includes a circumferential tear strip to facilitate removal of a portion of the capsule above the band of the absorbent material.

23. A device for collecting drips on an exterior of a fluid container comprising:
a band of material substantially impervious to the fluid disposed on the container proximate to an opening from which the fluid is dispensed;
means for positioning at least a proximal edge of the band of material in a spaced-apart relationship with the container so as to form a gutter in which drips of fluid are collected.

24. The device of claim 23 wherein the band of material encircles the container proximate to the opening.

25. The device of claim 23 wherein the band of material is secured to the container with an adhesive.

26. The device of claim 23 wherein the band of material is disposed beneath a capsule covering a portion of the container surrounding the opening.

27. The device of claim 23 further comprising an absorbent material disposed within the gutter.
